(19) United States
(12) Patent Application Publication
(10) Pub. No.: US 2005/0254920 A1
(43) Pub. Date: Nov. 17, 2005

(54) Motorcycle bolt head cover

(75) Inventor: Daniel G. Baughman, Fontana, WI (US)

Correspondence Address: FOLEY & LARDNER, 777 EAST WISCONSIN AVENUE, SUITE 3800, MILWAUKEE, WI, 53202-5308, US

(73) Assignee: Bergamont Brass Works, Inc.

(21) Appl. No.: 10/843,211

(22) Filed: May 11, 2004

(51) Int. Cl. F16B 37/14

(52) U.S. Cl. 411/372.5

(57) ABSTRACT

A cover for bolt heads of motorcycles preferably includes a recessed top and a skirt. In the illustrated and preferred embodiment, the skirt is annular and the recess is circular. The recess is adapted to receive a color matched object, such as a pre-painted insert or a cabochon made from a gemstone, ceramic, glass or plastic. The objects upper surface can be flat, domed, etc. Alternately, the recess is filled with a suitable color matched liquid, such as an epoxy or enamel liquid. In its most preferred forms, the object color matches at least one component of the motorcycle with which it will be used, e.g. the fenders, fuel tank, frame, etc.

Cross-reference to related patent applications, if any: None.

### FIELD OF THE INVENTION

The present invention relates generally to the field of decorative accessories for motorcycles. More specifically, the present invention relates to an article which covers exposed bolt heads of the motorcycle to provide a more desirable aesthetic appearance. Still more specifically, the present invention relates to a bolt head cover for motorcycles which includes two primary components, a cover and a round, decorative component which color matches at least one component of the vehicle, e.g. the gas tank, frame or fenders. In its most preferred embodiments, the present invention relates to motorcycle bolt head covers which include a skirt and a recess adapted to receive a pre-painted insert or a cabochon.

### DESCRIPTION OF THE PRIOR ART

The concept of covering nuts or bolts used for such purposes as attaching wheels to motor vehicles is known. Such covers are provided for aesthetic and utilitarian purposes, to prevent theft of vehicle wheels, to protect the vehicle components from dirt, mud or the like, to provide light reflection, or to conceal a structure residing beneath the cover, etc. For example, a “Motorcycle Axle Nut Cover” is described in the Davidson et al., U.S. Design Pat. No. 376,568, issued Dec. 17, 1996. The nut cover shown in the design patent includes an annular skirt, a flared top portion extending from the skirt inwardly to a planar, annular face encircling a recess.

Davidson, in U.S. Design Pat. No. 339,554, issued Sep. 11, 1993 for “Axle Nut Cover” describes a generally triangular shaped cover designed to hide components at the axle of a motorcycle wheel.

A nut cover is also shown in U.S. Pat. No. 4,900,206 issued Feb. 13, 1990, to Kazino et al., for “Nut with Cover.” This product is prepared from synthetic resin and includes a stepped recess and an internally threaded portion. Preferably, the product is made by injection molding and includes a frame and a covering plate positioned inside the frame and connected by a hinge. The frame also includes an integral part at its lower portion which engages a portion of the inner surface of the internally threaded portion. A preferred use described in the patent is to cover a nut located on the floor panel of a motor vehicle. The device is adapted to reduce the need to apply coatings on the nut to prevent rust and the like.

A further device for covering a nut and for covering a bolt head is shown in U.S. Pat. No. 6,305,890 issued Oct. 23, 2001 to Okamura for “Covering Device for Nut and Covering Device for Bolt Head.” This device includes two basic components which rotate relative to one another to prevent relative motion of the outer cover with respect to the nut. The primary use described in this patent is to prevent theft of wheels from cars.

Another design, this time shown for use with the tractor component of a semi-trailer tractor combination, is shown in U.S. Design Pat. No. 439,213, issued Mar. 20, 2001, to Huang for “Wheel Nut Cover.” This device includes a cylindrical and elongate outer surface, a generally triangular raised portion on the outer end and an inner surface having a hexagonal configuration to be placed over the nut on the truck wheels.

Lucht and Davidson disclose an “Axle Cover and Motorcycle Having the Same” in U.S. Pat. No. 5,881,835, issued Mar. 16, 1999. The particular cover shown in this patent covers not only the nut of a motorcycle wheel but also various components of the fork assembly, fender straps and the like. A hubcap can also be connected to a bushing such that the axle cover is compressed between the hubcap and the bushing.

Another but considerably older patent disclosing a cover for portions of a motorcycle is described in U.S. Pat. No. 4,967,867, issued Nov. 6, 1990 to Fuller for “Cover Assembly for Motorcycle Axle.” This product, designed especially for the wheel axle of a Harley-Davidson motorcycle, includes a recess which a customer fits around the various parts of the axle that project laterally beyond the side of the wheel and a mounting bracket to permit the cover to be attached by screws.

A relatively simple bolt and cover assembly is disclosed in U.S. Pat. No. 4,907,929, issued Mar. 13, 1990 to Johnston Jr., entitled “Bolt and Nut Cover.” In this device, the cover includes a body which has two cavities therein: a first to fit over the nut and a second which is cylindrical and has a diameter between those of the outer and inner thread diameters of the bolt. The cover is forced into engagement with the nut and is held in place by the interference resulting from the selection of the respective thread and cover diameters.

A still further “bolt cap device” is shown in Rosenbaum's U.S. Pat. No. 4,890,967 issued Jan. 2, 1990. In this device, legs are provided on the inner portion of the cover which align with flats on the bolt head. The cover includes two parts, a retainer having the flats and a cylindrical cover which forms a friction fit with the retainer and is applied thereover.

Yet a further “Cover for a Bolt and Nut” is described in U.S. Pat. No. 5,590,992, issued Jan. 7, 1997, to Russell. This product is a single piece reusable cover which includes a closed top, a generally cylindrical sidewall, and an internally threaded portion. The threads are adapted to mate with the external threads on a bolt extending through a nut, whereby the cover fits over the bolt and the nut by rotation of the fastener therethrough.

Other covers for vehicle components such as valve stems, screws, fork nuts, lug nuts and frame bolts are shown in various advertising submitted with this application. Such advertising in some cases shows dates, but no admission is made here that such advertising constitutes prior art to the present invention. None of this art shows the color matching feature of the present invention.

While a variety of covers are disclosed in these various patents, publications and advertising, the main feature of many of them is utilitarian, and none disclose bolt head covers for motorcycles which color match the color of the motorcycle or particular components thereof. With customization of motorcycles being very popular, some involving thousands of dollars of OEM or after-market components to enhance the overall visual appeal of the vehicle. A need exists for color matching the large number of bolt heads which are used to assemble motorcycles. Providing bolt head covers which strikingly enhance the visual characteristics of a motorcycle would, therefore, represent a significant advance in the art.

### FEATURES AND SUMMARY OF THE INVENTION

A primary feature of the present invention is to provide a cover for motorcycle bolt heads.

Another feature of the present invention is to provide bolt head cover for motorcycles which enhances the overall vehicle appearance.

A different feature of the present invention is to provide a bolt head cover for motorcycles which, in an illustrated embodiment, is round in shape.

A still further feature of the present invention is to provide a round, pre-painted color matched insert for a bolt head cover for motorcycles.

A still further feature of the present invention is to provide a round color matched portion of a cover for a bolt head on a motorcycle which has, in preferred embodiments, a flat domed, or concave appearance.

A different feature of a preferred form of the present invention is to provide a round cabochon adapted to be placed in a recess of a bolt head cover for a motorcycle, the cabochon being prepared from such materials as gemstone, glass, ceramic or plastic which color matches one or more components of the motorcycle.

Another feature of the present invention is to provide a bolt head cover for motorcycles which may be readily attached using common tools.

How these and other features of the present invention are accomplished will be described in the following detailed description of the preferred embodiments of the invention, taken together with the drawings. Generally, however, the features are accomplished in a generally hollow bolt head cover adapted to fit over and surround a bolt head, the cover preferably being attached by using a hex screw or by friction engagement. An annular recess is preferably provided at the closed end of the cover, and a round colored object is placed therein. The object may be a separate piece, such as a painted insert or a cabochon prepared from gemstone, glass, ceramic or plastic, any of which may have a flat, domed, or other shaped outer surface. Alternately, a colored liquid material may be placed in the recess, at least partially filling same, the liquid material being thereby attached to the body of the bolt head cover. Examples of such materials include enamels, epoxy resins, or the like. The bolt head cover need not have the recess, in which case the round, colored object is affixed directly on the closed end. In either case, the result is a cover that performs the utilitarian function of covering the bolt head, but it also color matches the motorcycle or at least one component thereof in a distinctive, jewel-like manner. The relative proportions of the cover may be varied widely, including the size of the recess. The preferred color for the round, colored object is an exact match to the motorcycle color, e.g. that of the gas tank, frame or fender. The recess, if used, should be round. Other ways in which the features of the present invention are accomplished will become apparent to those skilled in the art after they have read this specification, and such other ways are deemed to fall within the scope of the present invention if they fall within the scope of the claims which are presented at the end of the specification.

### BRIEF DESCRIPTION OF THE DRAWINGS

In the following drawings, similar reference numerals are used to designate like components.

FIG. 1 is a perspective view of a bolt head cover according to a preferred embodiment of the present invention and including a domed insert;

FIG. 2 is a perspective view of the cover shown in FIG. 1, without the insert;

FIG. 3 is a sectional view of the body of the cover shown in FIGS. 1 and 2 and illustrating a recess and the set screw used for securing the cover;

FIG. 4 is an exploded view, partially in section, showing the domed insert positioned above the recess;

FIG. 5 is a perspective view of an alternate embodiment of the present invention including a flat, protruding insert; and

FIG. 6 is a perspective view of a second alternate embodiment of the present invention showing a partially filled recess having a flat outer surface.

### DETAILED DESCRIPTION OF THE PREFERRED AND ALTERNATE EMBODIMENTS

Before beginning the description of the preferred and illustrated alternate embodiments, several general comments should be made about the applicability and the scope of the present invention.

First, the bolt head covers of the present invention find their most advantageous utility in the motorcycle field.

Second, the body material used to construct the covers of the present invention may be selected from a wide variety of metals, alloys, plastics, and the like. In the preferred embodiment, the body is made from chrome plated zinc, polished aluminum, or stainless steel, which may be chrome-plated or vacuum metalized.

Third, while all of the FIGURES illustrate a cover having a generally cylindrical external shape, the cover of the present invention may have any of a variety of other shapes, including being square or hexagonal in horizontal cross section with reference to the display of the invention in the drawings. Other symmetrical or non-symmetrical shapes may also be employed, as long as the round color matched object feature of the present invention is utilized.

Fourth, one particular technique is shown and described for securing the nut cover to the bolt head, i.e., a set screw. Any other technique could also be employed, including an interference or friction fit, adhesives, retainers, or frames such as those described in the art discussed earlier in this specification.

Fifth, the color matched object may be a separate piece which is added and secured to the cover base, such as a pre-painted insert or a cabochon prepared from gemstones, glass, ceramic, or plastic. Alternatively, a liquid material such as an epoxy or enamel may be applied (such as by injecting, spraying, or painting). What is important is that the material which is added to the cover be capable of providing an aesthetically pleasing enhancement to the motorcycle by being color matched to a component thereof. The quality, surface characteristics, shine, luster, sparkle, or other type of aesthetic enhancement may be subtle or a jewel-like effect may be created, which is particularly appealing in the custom motorcycle field.

Sixth, the exposed portion of the color matched object is illustrated in the drawings as being round, and that shape is preferred.

Seventh, the bolt cover of the present invention may be prepared by a manufacturer of accessories for motorcycles, or the cover may be supplied to riders or those involved in the custom design of the vehicles by aftermarket suppliers. In the latter case, the object should match at least one component of the motorcycle.

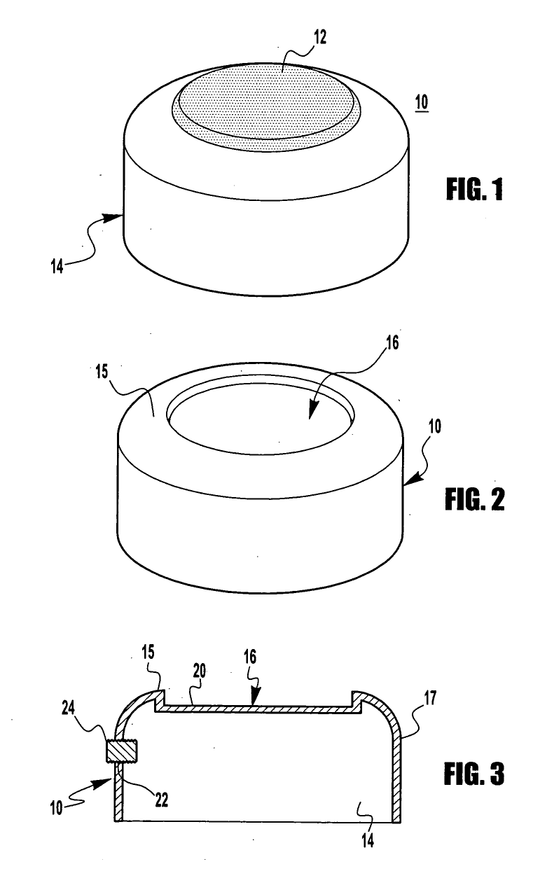

Proceeding now to a description of the preferred and illustrated embodiments, FIG. 1 shows a cover 10 comprising a domed insert 12 and a generally cylindrical base 14. The cover 10 is shown again in FIG. 2, without insert 12, but illustrating a recess 16 formed in the upper portion 15 of the base 14. Recess 16 has a floor 20.

The particular configurations of cover 10 may better be appreciated from the sectional view of FIG. 3 which shows that base 14 is hollow and includes an annular skirt 17 and an open bottom. Skirt 17 is generally rounded at its top 15 surrounding recess 16.

A preferred attachment technique is also illustrated in FIG. 3, i.e., a threaded opening 22 is provided in wall 17, and a set screw 24 extends therethrough. In its most simple form, the cover is placed over the nut, the screw 24 being aligned with one of the flats of the bolt head (not shown). The screw 24 is turned until an interference/clamping attachment is completed.

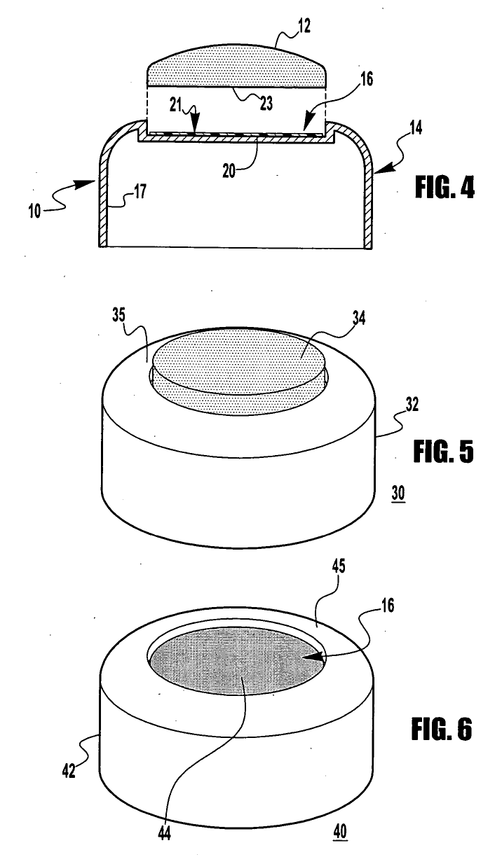

FIG. 4 shows in exploded form insert an 12 above recess 16. The illustrated insert includes a planar bottom surface 23 adapted to be received within recess 16. A layer of adhesive 21 is illustrated and is used to hold components 12 and 14 together securely. Many different types of attachment techniques can be employed, including the use of double-sided tape, liquid adhesives, hot melt adhesives, and the like, the general requirements being that the fastening system employed should be capable of withstanding the shock forces and temperature extremes which are normally encountered during use of the motorcycle. The choice of any particular adhesive system would be readily appreciated by one of ordinary skill in the motorcycle accessory art.

Proceeding next to FIG. 5, another cover 30 is shown. This cover includes a base 32, and color matched insert 34 which has a flat shape when compared to the domed shape embodiment of FIG. 1. In this embodiment the insert extends above the top 35 of base 32.

A still further cover 40 is shown in FIG. 6. Again, the cover includes a base 42 configured similarly to that of the other drawings, but instead of insert 12 or 34, the recess 16 is partially filled with a liquid material which hardens to form a contrasting disk 44. Disk 44 may completely fill recess 16 or may only partially fill it, in which case it lies below the top 45 of base 42.

While three embodiments of the present invention have been described in connection with the FIGURES, the early paragraphs of this section of the specification point out a wide variety of changes which may be made and which will be readily apparent to those skilled in the art after they have read the entire description. Accordingly, the scope of the present invention should not be limited to any of the features shown specifically in the illustration, but rather should be limited solely by the scope of the claims which follow.

1. A cover for motorcycle bolt heads comprising a body, the body being at least partially hollow and adapted to cover the bolt head, the body having an external surface, and a round object located on the external surface and including material different than the material from which the body is made, the object being color matched to at least one component of the motorcycle for which the cover is intended to be used.

2. The cover of claim 1, wherein the external surface includes a recess and at least part of the object is located in the recess.

3. The cover of claim 2, wherein the color matched object is selected from the group consisting of pre-painted inserts, cabochons, or a hardened resin fill.

4. The cover of claim 1, wherein the object is prepared from a liquid resin placed in the recess and hardened therein.

5. The cover of claim 4, wherein the liquid resin is an epoxy resin or an enamel paint.

6. The cover of claim 1, wherein the recess is circular and wherein the object extends outwardly from the external surface.

7. The cover of claim 6, wherein the object has a domed external surface.

8. The cover of claim 6, wherein the object has a planar external surface.

9. The cover of claim 1, wherein the object is located entirely within the recess.

10. The cover of claim 9, wherein the object includes a planar external surface.

11. The cover of claim 1, wherein the object is attached to the body with an adhesive.

12. The cover of claim 1, further including a set screw to hold the cover against the bolt head.

13. A motorcycle bolt head cover comprising a body having a cavity adapted to fit over a motorcycle bolt head, the cavity having an opening allowing the cover to be placed over the bolt head, and the cavity being at least partially encircled by a skirt, the cover also having a closed end, a recess formed in the closed end and an insert located in the recess, the insert being color matched to at least one component of the motorcycle, for which it is adapted to be used.

14. The cover of claim 13, wherein the recess is generally cylindrical and the insert fills the recess and extends outwardly beyond the closed end.

15. The cover of claim 17 wherein the insert is made of a material selected from the group consisting of pre-painted inserts or cabochons made from gemstone, plastic, ceramic and metal.

16. The cover of claim 15, wherein the insert is a hardened plastic disc formed by placing a color matched hardenable liquid in the recess and hardening the liquid.
